(19) United States
(12) Patent Application Publication
(10) Pub. No.: US 2005/0265911 A1
(43) Pub. Date: Dec. 1, 2005

(54) Gas absorption column and a method of chemically treating an acid gas using such a gas absorption column

(76) Inventor: Hongqi Yuan, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/140,468

(22) Filed: May 27, 2005

(30) Foreign Application Priority Data
May 28, 2004 (CA) 2,470,807

(51) Int. Cl. C01B 17/16

(52) U.S. Cl. 423/220

(57) ABSTRACT

A method of chemically treating an acid gas, includes the steps of immersing a micro-porous membrane having a plurality of micro-pores in a liquid containing a reactant chemical and passing a gas stream containing an acid gas under pressure through the micro-porous membrane. The acid gas passes through the micro-pores to form micro-bubbles which float up through the liquid and react with the reactant chemical. A number of configurations of gas absorption columns are described as being suitable for use in accordance with the teachings of this method.

### FIELD OF THE INVENTION

The present invention relates to a gas absorption column and, in particular, a gas absorption column which utilizes a novel contactor and a novel process flow to chemically treat an acid gas.

### BACKGROUND OF THE INVENTION

In a chemical absorption reaction, an acid gas is chemically absorbed and separated by a liquid which contains reactant chemicals. The reaction is then reversed to release the acid gas, so that the reactant chemicals can be reused. One example of a chemical absorption reaction is the reaction of CO₂ gas with aqueous amine. The treatment of CO₂ gas emissions has recently been a focus of attention, in view of global concerns regarding harm to the environment being caused by greenhouse gas emissions.

### SUMMARY OF THE INVENTION

What is required is an improved configuration of gas absorption column and an improved method of chemically treating an acid gas.

According to the broadest aspect of the present invention there is provided a method of chemically treating an acid gas, comprising the steps of immersing a micro-porous membrane having a plurality of micro-pores in a liquid containing a reactant chemical and passing a gas stream containing an acid gas under pressure through the micro-porous membrane whereby the acid gas passes through the micro-pores to form micro-bubbles which float up through the liquid and react with the reactant chemical.

In order chemically treat a gas stream containing an acid gas in accordance with this method, a gas absorption column is provided with a housing adapted to hold a liquid containing a reactant chemical. The housing has a gas inlet and a gas outlet. A micro-porous membrane having a plurality of micro-pores is interposed between the gas inlet and the gas outlet. A gas stream containing an acid gas entering the housing under pressure through the gas inlet must pass through the micro-porous membrane in order to exit the housing via the gas outlet. The gas stream passes through the micro-pores as micro-bubbles which float up through the liquid in order to reach the gas outlet while a reaction occurs between the acid gas and the reactant chemical in the liquid.

As will hereinafter be further described, inorganic salt-based absorbing solvents, such as potassium carbonate, have an inherent disadvantage when used in a chemical absorption process in that they provide a slow reaction rate. However, the slow reaction rate can be accommodated by the use of micro-porous hollow fibre membranes. Firstly, the micro-bubbles produced by passing gas through micro-pores in the micro-porous hollow fibre membranes provide a much higher gas-liquid contact area. Secondly, when micro-porous hollow fibre membranes are used there is greater control over gas and liquid phase pressures and flow rates, which can be used to compensate for the slower reaction rate.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation view, in section, of a micro-porous membrane.

FIG. 2 is a side elevation view, in section, of a gas absorption column constructed in accordance with the teachings of the present invention.

FIG. 3 is a detailed side elevation view, in section, of a micro-porous hollow fibre membrane module from the gas absorption column illustrated in FIG. 2.

FIG. 4 is a side elevation view, in section, of the gas absorption column illustrated in FIG. 2, connected with a regeneration column.

FIG. 5 is a side elevation view, in section, of an alternative micro-porous hollow fibre membrane module.

FIG. 6 is a plan view of a gas absorption column using the micro-porous hollow fibre membrane module of FIG. 5.

### DETAILED DESCRIPTION OF THE PREFERRED EMBODIMENT

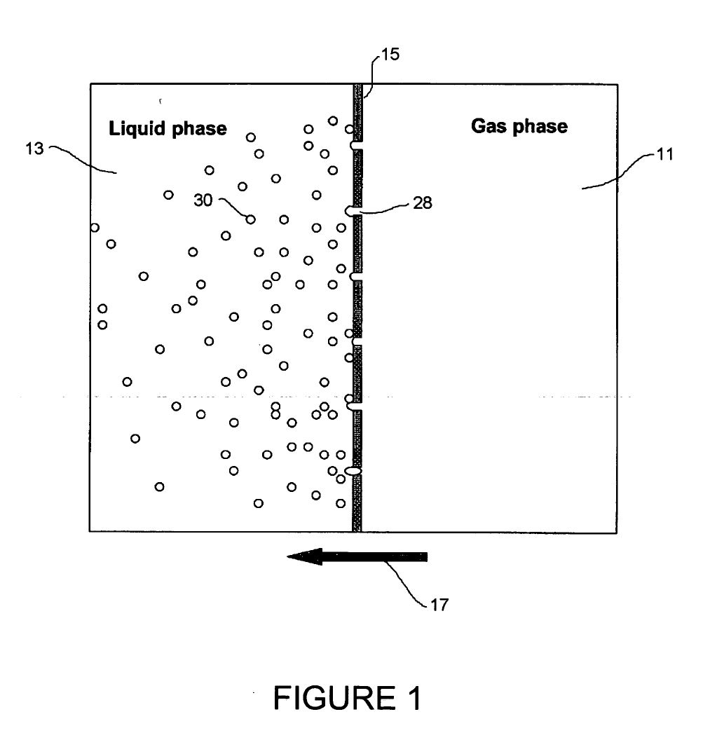

The preferred embodiment, a gas absorption column generally identified by reference numeral 10, will now be described with reference to FIGS. 1 through 6.

Structure and Relationship of Parts

Referring to FIG. 1, the general concept of a microporous membrane is shown.

There is a gas phase 11 and a liquid phase 13 with a micro-porous membrane 15 which acts as a barrier to separate the two phases. A pressure difference is applied across membrane 15, where the arrow 17 represents the direction of force caused by the pressure difference. As a result, the gas phase, which has a higher pressure, will be pushed across membrane 15 through the micro-pores 28 in membrane 15. The resulting gas micro-bubbles 30 will disperse into liquid phase 13. The size and size distribution of micro-bubbles 30 will depend on the size of the micro-pores on membrane 15.

The concept of generating micro-bubbles of gas is independent from the configuration of the membrane. In other words, it doesn't matter if the membrane is a flat sheet or a hollow tube. As long as a membrane has micro-pores and there is a pressure differential favoring the gas phase side, the micro-bubbles will be generated in the liquid phase. In the embodiments described herein, a hollow tube is used as the membrane as it presents certain advantages which will be apparent from the discussion, however, it will be understood that a flat membrane, or any other size and shape of membrane, could be substituted in the embodiment without departing from the invention.

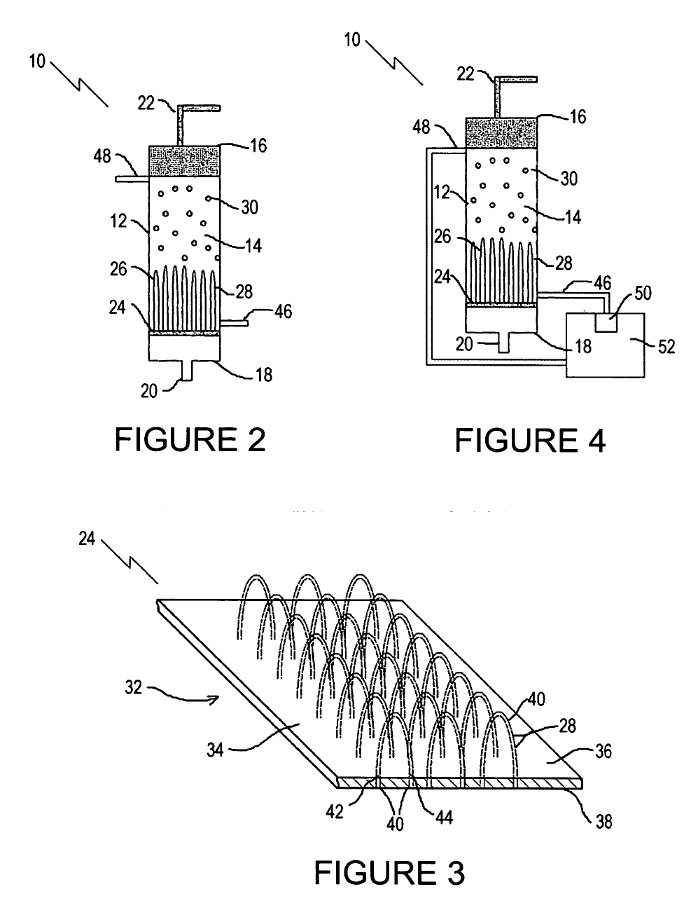

Referring now to FIG. 2, there is shown a gas absorption column 10. A housing 12 is adapted to hold a liquid 14 containing a reactant chemical. Housing 12 has a top 16 and a bottom 18. There is a gas inlet 20 positioned toward bottom 18 of housing 12, and a gas outlet 22 positioned toward top 16 of housing 12. A sparger 24 is positioned between gas inlet 20 and gas outlet 22. Sparger 24 is in the form of a micro-porous hollow fibre membrane 26, preferably using polysulfone fibre, which has a plurality of micro-pores 28. Sparger 24 is connected to gas inlet 20, such that an acid gas passing through gas inlet 20 enters sparger 24 and then exits micro-pores 28 as micro-bubbles 30 which float up through liquid 14 in order to reach gas outlet 22, while a reaction occurs between the acid gas and the reactant chemical in liquid 14.

Referring now to FIG. 4, housing 12 has a liquid inlet 46 and a liquid outlet 48. Liquid 14 containing the reactant chemical is circulated into the housing through liquid inlet 46 and out of housing 12 through liquid outlet 48. This may be done by a pump 50 or other means of applying a pressure differential. Liquid outlet 48 and liquid inlet 46 are connected to a recovery and regeneration unit 52, such that liquid 14 is continuously drawn from liquid outlet 48 into regeneration unit 52 for regeneration and regenerated liquid 54 is returned to liquid inlet 46.

Referring again to FIG. 3, sparger 24 is in the form of a sparger module 32 which includes a mounting plate 34 and a plurality of micro-porous hollow fibre membrane loops 40. Mounting plate 34 has a first face 36, a second face 38, and a plurality of openings 40 that extend through mounting plate 34 between first face 36 and second face 38. Micro-porous hollow fibre membrane loops 40 have opposed ends 42 and 44, each of opposed ends 42 and 44 being in fluid communication with one of the openings 40 on second face 38, such that acid gas 24 enters openings 40 from first face 36 of mounting plate 34, passes into opposed ends 42 and 44 of micro-porous hollow fibre membrane loops 40 as it reaches second face 38 of mounting plate 34 and can only exit micro-porous hollow fibre membrane loops 40 by passing through micro-pores 28.

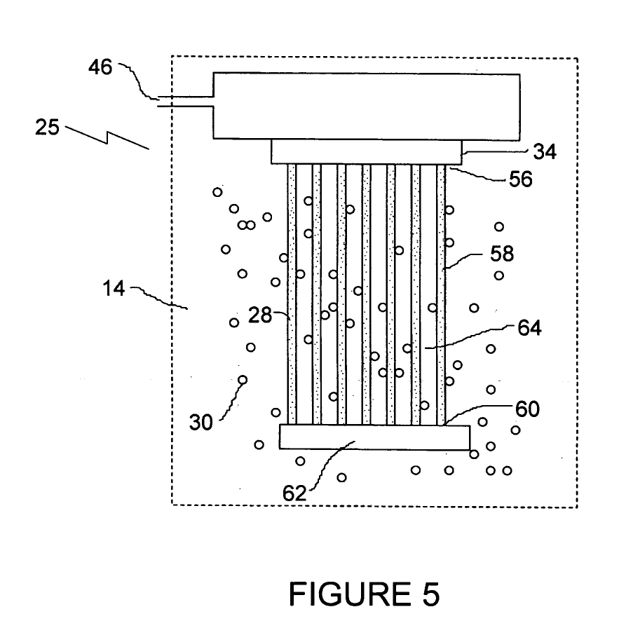

Referring now to FIG. 5, another embodiment of a sparger 25 is shown. In this embodiment, mounting plate 34 is in the form of a manifold which only connects with a first end 56 of micro-porous hollow fibre membrane lengths 58, which replace micro-porous hollow fibre membrane loops 40 in FIG. 3. A second end 60 of length 56 is connected to a sealed block 62. Sealed block 62 may be hollow to allow fluid communication between second ends lengths 58 to help keep the pressure equalized throughout all lengths 58, which together form a bundle 64 or sealed block may block the opposed ends of the micro-porous hollow fibre membrane lengths. As first ends 56 are in fluid communication, communication between fibres is not required. Gas pressure is applied through gas inlet 46, such that lengths 58 become pressurized, and acid gas can only exit through micro-pores 28 in the form of micro-bubbles 30, and pass through liquid 14 as they rise.

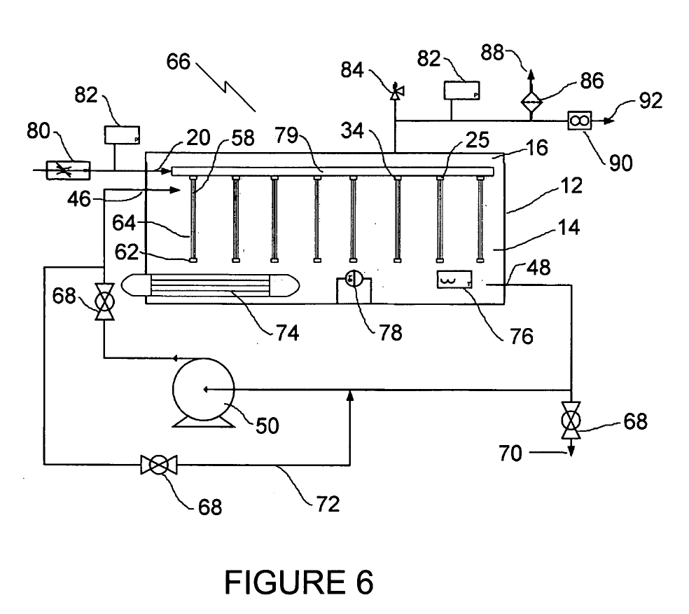

Referring now to FIG. 6, another layout of a gas absorption column 66 is shown. Liquid 14 circulates though housing 12 by means of pump 50. There are valves 68 which allow a user to send liquid 14 to a drain 70, to turn off liquid flow to housing 12, or to allow flow control through a bypass 72. Inside housing 12 there is a heater 74, a thermocouple 76, and a level switch 78. Heater 74 and thermocouple 76 are spaced apart such that a more accurate reading of the temperature of liquid 14 can be obtained, resulting in better temperature control. Level switch 78 allows the level of liquid 14 in housing 12 to be monitored. Acid gas enters sparger 25 through gas inlet 20, which is placed closer to top 16 of housing 12 such that gravity pulls sealed block 62 down, thus keeping bundles 64 of lengths 58 vertical. Multiple spargers 25 are connected to a manifold 79. The flow of gas from a gas source (not shown) to gas inlet 20 is controlled by a flow controller 80 and a pressure transducer 82. Gas outlet 22 is connected to a relief valve 84 with, for example, a 15 psi setpoint. A pressure transducer 82 is also connected to gas outlet 22. A coalescing filter 86 is connected to a sample line 88 to GC (gas chromatography) to analyze the output gas, while a flowmeter 90 measures the flow of gas as it proceeds to a vent 92.

Operation

The operation of the preferred embodiment will now be discussed with reference to FIGS. 1 to 5. Referring to FIG. 2, micro-porous hollow fibre membrane 26 having a plurality of micro-pores 28 is immersed in liquid 14 containing a reactant chemical. Micro-porous hollow fibre membrane 26 is filled with acid gas 24 under pressure. As such, acid gas 24 passes through micro-pores 28 to form micro-bubbles 30 which float up through liquid 14 and react with the reactant chemical. As shown in FIG. 3, micro-porous hollow fibre membrane 26 is in the form of multiple loops 40 with opposed ends 42 and 44 such that acid gas 24 is fed into loops 40 from each of the opposed ends 42 and 44. It will be understood that the number of loops will be use-dependent. The acid gas may be carbon dioxide (CO₂), hydrogen suphide (H₂S), or amine (MEA), while the reactant chemical may be potassium carbonate (K₂CO₃), or another inorganic salt-based absorbing solvent.

Referring to FIG. 4, a further step of steam regeneration in the regeneration unit 52 of liquid 14 containing the reactant chemical is used, where liquid 14 is continuously drawn form liquid outlet 48 and returned to liquid inlet 46, in which case the inorganic salt-based absorbing solvent must be capable of reacting in a reversible reaction with CO₂ as a reactant chemical.

Advantages

The use of micro-porous hollow fibre membranes significantly increases gas-liquid contact area The gas-liquid surface contact area obtained using micro-porous hollow fibre membranes is estimated to be 30 to 100 times that obtained through the use of conventional packed columns. Capital cost savings can be realized using the above described micro-porous hollow fibre membranes. The micro-porous hollow fibre membrane modules are lightweight, compact and flexible. The micro-porous hollow fibre membranes do not corrode.

The micro-porous hollow fibre can be used to improve the absorption efficiency of existing aqueous amine processes. However, use with an inorganic salt-based absorbing solvent, such as potassium carbonate, has been found to provide a number of advantages, as compared to aqueous amine processes. The cost of chemicals is lower. Lower steam usage is required during regeneration. There is little or no oxidation and degradation. There is low hydrocarbon solubility.

Information Regarding Properties and Selection of Fibre

Stability Tests of PVDF Fibre

According to previous experience, the amine based solution attacks the PVDF (polyvinylidene fluoride) fibre in a short period of time, even in ambient temperature and pressure. Therefore, the first step was the evaluation the stabilities of two polymers, PVDF and polysulphone, in inorganic based solutions. The stability test was conducted by soaking the fibre in a test solution in a glass jar under ambient temperature and elevated temperature. The basic testing solutions were potassium carbonate solution with different concentrations. Piperazine(PZ) was also mixed with potassium carbonate solution, mainly to function as catalyst. The results of stability test of PVDF fibre are given in Table 1 below:

TABLE 1
The stability of the PVDF hollow fibre
in Potassium carbonated solutions.

| | | Piper- | | |
|---|---|---|---|---|
| Solu- | K₂CO₃ | azine(M) | Temper- | |
| tion | (M) | (C₄H₁₀N₂) | ature | Observations |
| 1 | 2 | | 25° C. | OK over 6 weeks, still OK |
| 2 | 2 | 0 | 55° C. | Fiber turns light pink after 24 |
| | | | | hours |
| 3 | 3 | 0 | 55O C. | Fiber turns light pink after 24 |
| | | | | hours |
| 4 | 5 | 0 | 55° C. | Fiber turns pink after 3 hours |
| 5 | 2 | 0.3 | 55O C. | Fiber turns pink after 1 hour, |
| | | | | dark pink after 24 hours |
| 6 | 3 | 0.3 | 55° C. | Fiber turns pink after 1 hour |
| | | | | and turns brown over Night |
| 7 | 0 | 0.6 | 55° C. | Pink after 1 hour, light brown |
| | | | | over night |

For comparison, commercial PVDF flat membrane was also tested under the same conditions. The results indicate that the piperazine amine attacks the PVDF fiber at the elevated temperature with or without the potassium carbonate. Potassium carbonate also adds some degree of coloration to the PVDF fibre at elevated temperatures. At room temperature, the PVDF fibre survived. Another observation was that PVDF fibre started changing color at the part which opens to air. Oxygen from air has been considered to cause the PVDF fibre to change the color. Therefore, another test was conducted by bubble the soaking solution with nitrogen to remove oxygen, then soaking the fibre in an oxygen free solution. The results still show that piperazine attacks the PVDF fibre. The commercial PVDF flat membranes also show some coloured spots at elevated temperature. Based on these tests, it seems feasible for using potassium carbonate solution (2M) and PVDF fiber absorbing at room temperature.

Stability Tests of Polysulphone Fibre

There is no confirmed information about the stability of polysulfone fiber in potassium carbonate based solutions. The stability tests were also conducted by soaking the polysulfone fiber in four different absorbing solutions in glass vials at room temperatures and at elevated temperatures. Visual observations were recorded at different times.

Results are given in Table 2. The note “OK” in the table refers to: no visible color change, no opacity change of the soaked fiber.

TABLE 2
The stability of the polysulphone fiber
in Potassium carbonate solutions.

| | | After 24 | After 96 | After 336 | After 432 |
|---|---|---|---|---|---|
| Solution | Temperature | hours | hours | hours | hours |
| 2 M K₂CO₃ | Room temp. | OK | OK | OK | OK |
| 2 M K₂CO₃ | Room temp | OK | OK | OK | OK |
| & O.3 M PZ | | | | | |
| 2 M K₂CO₃ | 50° C. | OK | OK | OK | OK |
| 2 M K2CO3 | 50° C. | OK | OK | OK | OK |
| & O.3 M PZ | | | | | |

In general, the color change normally indicates some chemical reaction occurred on the polymer surface. The opacity change is the indication of the wet-ability change. The summary from this test is that polysulfone fiber does not change significantly in a potassium-based solution at room temperature and 50° C.

Flow Rate Test Results From PVDF and Polysulfone Fibre

A group of PVDF fibre loops was set up and soaked in 2M potassium carbonate solutions, in a sealed glass cylinder. The feed gas was pressurized through the micro pores from the fibre wall and was bubbled through the testing solution. The off gas was connected to a soap bubble flow meter and the off gas flow rates were recorded. The initial feed gas pressure was at 20 psi, and the result was plotted in Table 3. There was a constant drop in the flow rate at the given pressure which indicated that the micro pores from the fibre wall were plugging. After about 7 hours, the feed gas pressure was increased to 40 psi. There was some gain of the off gas flow rate with the increase of feed gas pressure, but it dropped to near zero within two and half days. The similar test of the off gas flow rate from polysulfone fibre loops were also given in Table 4. The results indicate that the off gas flow rate drop of PVDF fibre is much faster than that of polysulfone fibre. It is obvious that the fact of flow rate dropping is directly related to the plugging of the micro pores on the fibre wall. The flow rate dropping for the polysulfone fibre is initially quite fast at the given pressure. The flow rate can then be keep relatively steady for a period of time, although there is some insignificant dropping. The fast initial dropping is due to the fast plug of a group of very small pore on the fibre wall.

[image]

[image]

It was determined that a polysulfone fibre bundle was an acceptable option. Concerns for a polysulfone fibre bundle setting are:
1) In order to come the hydrophilic nature of the polysulfone fibre, the pressure from the gas phase has to high enough to balance the capillary pressure from the micro pores.
2) On the other hand, when the pressure goes high enough, gas was started penetrate the fibre wall through the bigger pores and goes into the liquid phase.
3) Therefore, the size distribution became an important factor.
   In Addition, We Have Learned That
1) Polysulfone fiber is not attacked by 2M potassium carbonate solution at room temperature or elevated temperature (50° C.).
2) Polysulfone is not wet by 2M potassium carbonate solution for longer than 10 days. The idea of using polysulfone hollow fibre as sparger by pressurizing the gas through the fibre wall into the liquid phase was chosen for implementation.

Configuration of Fibre

The schematic diagram of the hollow fibre sparger unit is given in FIG. 2. The key part of the sparger unit is a replaceable fibre loop mounting plate. It is a plastic plate with drilled holes, which could thread the fibre as loop and sealed with 2-TON clear epoxy. The number of the holes and the length of the fibre loop were changeable and allowed to adjust the membrane area. Then the fibre loop mounting plate was mounted in a plastic cylinder. The cylinder can hold a certain amount of absorbing liquid. The absorbing liquid can also be pumped through the cylinder in a controlled flow rate. Because fibre loop is sealed onto the mounting plate, the feed gas can only pass through the fibre wall and merge into the liquid phase. Then the off gas will be sent to GC to analyze. The bubble size generated from hollow fibre is directly related to the pore size of the fibre wall.

TABLE 5
Polysulfone hollow fibre sparger tests and some key factors

| | | Total fibre | Total |
|---|---|---|---|
| Test | Total operation | length | surface area |
| Number | time (hour) | (cm) | (cm²) |
| Run #1 | 213 | 216 | 8.5 |
| Run #2* | 230 | 216 | 8.5 |
| Run #3 | 550 | 600 | 23.6 |

′″ Run #2 was using same set of fibre loops as #1. The mounting plate was taken out after #1 run. The fibre loops was rinsed with water al lll air dried and then remounted in for #2 run.

Three sets of experiments data has been collected using this sparger unit (see Table 5.) The measurable factors are:
1) Total fibre length/membrane surface area.
2) Total running time.
3) Feed gas pressure.
4) Off gas CO₂ content.
5) Off gas flow rate.
6) Absorbing solution conversion rate.
   Summarised Results From Run #1

The input gas is 15% CO₂ and 85% N₂. The absorbing solution is 2M K₂CO₃. The feed gas pressure is set up at 20 psi (1.36 atm). The CO₂ concentration in off gas is monitoring and recording by GC during the run time. Total operation time is 213 hours or about 9 days. Some key operation factors are given in Table 6.

TABLE 6
Selected operation factors from test Run 1

| | |
|---|---|
| Operation factors and numbers | Unit |

| | | |
|---|---|---|
| Solution flow rate | 0 | ml/hr |
| Total Solution volume | 750 | ml |
| Solution concentration | 2.0 | M |
| Total moles of K₂CO₃ | 1.5 | Mole |
| Feed gas CO₂ concentration | 15 | % |
| Feed gas pressure | 20 | psi |
| Average off gas flow rate | 720 | ml/hr |
| Total operation hours | 213.0 | hours |
| Total feed gas volume | 153.4 | Liter |
| Total feed CO₂ | 23.0 | Liter |
| Total fibre length | 216.0 | Cm |
| Total fibre surface area | 8.5 | cm2 |
| Estimated absorbed CO₂ * | 1.105 | Mole |
| % of converted K2CO3 | 73.62 | % |

* The estimation is based on an average of 1.00% CO₂ in off gas or 99% of CO₂ has been absorbed.

The off gas CO₂ concentration detected by GC during the operation hours was plotted in Table 7. The CO₂ concentration in off gas dropped to 0.4% within one hour. The CO₂ concentration in off gas started increasing and gradually went up to ˜4% at the end of test. The solution flow rate for this test is zero and the total volume is 750 mL. The reason that CO₂ concentration started increasing is the K₂CO₃ solution is getting saturated.

[image]

During the testing time, the off gas flow rate was also measured manually using a soap bubble flow meter. The result was given in Table 8. The flow rate dropped gradually but not significantly from the beginning till 151 hours, although it dropped more closer the end of experiment. During the test, the off gas flow rate was increased by increasing the feed gas pressure. The speculation of off gas flow rate dropping was initially pointed to the wetting of the micro pores.

After the first test was done, the re-mountable fiber loop plate was taken out and the fiber loops were rinsed by water and dried overnight. The same set of fiber loops was mounted in again and started the second run.

Results and Comparison Between Run #1 and Run #2

Since the run #1 and #2 used the same set of fibre loops, the result comparison seems necessary to evaluate the performance of the fibre loop after the washing and drying. The off gas CO₂ content and flow rate for both runs are plotted in Tables 9 and 10 respectively. For both run #1 and #2, we used fixed amount of absorbing solution, the total volume is about 750 mL.

[image]

Both runs last over 200 hours. For run #2, the used feed gas pressure was 30 psi, instead of 20 psi used in run #1. In terms of CO₂ absorbing efficiency for both runs, the first 100 hours are very similar, it seems independent from the feed gas pressure. After operation over 100 hours, the off gas CO2 contents from two runs show the difference. The second run has higher feed gas pressure and higher off gas flow rate, therefore, the absorbing liquid strength will drop faster. As a consequence, the absorbing reaction equilibrium might shift and cause the decrease in absorbing efficiency. This reaction equilibrium shift can be controlled by pumping in fresh absorbing solution.

As one of the important parameter, off gas flow rate was related to the performance capacity of the fibre loops, i.e. the efficiency of specific membrane surface. The observation from both run #1 and #2 is that the off gas flow rate dropping gradually, but the higher feed gas pressure has higher off gas flow rate.

[image]

[image]

Since we used the only one batch absorbing solution (750 mL) in run #1 and run #2, there was no circulation of absorbing liquid. When the operation reach about 150 hours for this set of fibre loops, the clear crystal started appear in the absorbing liquid. The analysis using Raman spectroscopy later on these crystals indicated that they are potassium bicarbonate. The solubility of potassium bicarbonate is much smaller than that of potassium carbonate at room temperature. Therefore the potassium bicarbonate precipitates out for the liquid phase. The growths of these crystals are detrimental to the sparging operation, maybe also is part of the cause of the off gas flow rate drop.

Results and Observation From Run #3

The third run was set up for two different reasons: 1) total fibre length was increased in order to increase the operation capacity; 2) circulate the absorbing solution to avoid the potassium bicarbonate precipitation.

The total fibre length in run #3 was about 600 cm. According to fibre dimensions measured from electronic scanning image the actual total fibre surface area is 23.5 cm². While the total surface area of the fibre set for run #1 and #2 is 8.5 cm². The feed gas pressure was 30 psi during the most time of the third run. Both flow rate and off gas CO₂ content were recorded during the third run. The total operation time terminated at 550 hours (23 days).

During the third run, the absorbing solution was changed three times at the 143, 243, and 377 operation hours respectively. Meanwhile, the drained absorbing solution was collecting to test the potassium carbonate conversion rate using Raman spectroscopic analysis.

The off gas content variation regarding the change of the absorbing liquid is shown in Table 11. The time and time intervals between the absorbing solution changes are given in Table 12. The off gases CO₂ content at the solution changing time and the potassium carbonate conversion rate of the drained solutions are also included in Table 12.

[image]

TABLE 12
Absorbing solution changing time and potassium
carbonate conversion rate during the run #3

| | Solution changing | | | | |
|---|---|---|---|---|---|
| | | | | | Final |
| | #1 | #2 | #3 | #4* | train |
| Time in- | 0-143 | 143-234 | 234-377 | 377-508 | 510-550 |
| tervals | | | | | |
| Number of | 143 | 91 | 143 | 131 | 40 |
| Operation | | | | | |
| hours | | | | | |
| Off gas CO2 | 2.179 | 1.983 | 2.283 | 2.287 | 7.822 |
| content (%) | | | | | |
| K2CO3 | n/a** | 49.5 | 52.5 | n/a* | 73.5 |
| conversion | | | | | |
| rate (%) | | | | | |

*Not change absorbing solution at the 508 hours; this point is selected according to the same CO2 content in off gas to compare the number of operation hours.
**The first absorbing solution change was pumping the fresh solution through instead of drain.

During run #3, each solution changing time interval can be considered as a cycle, each cycle has similar operation time and similar absorbing efficiency cycle except for the second cycle. The shorter operation time and slightly lower in absorbing efficiency is the mainly because the different way has been used in changing the absorbing solution. Although there is no potassium carbonate conversion rate data for #1 and #4 cycle, the combination of CO2 content in off gas and the off gas flow rate could still provide the help to estimate the potassium carbonate conversion rate.

As we mentioned previously, one other purpose for the third run is try to increase the performance capacity by increase the total fibre length or the available membranes surface area. The optimization of absorbing efficiency and the off gas flow rate can be the can be used as the criteria for overall performance. Therefore, the off gas flow rate is one of the most important factor to measure. Table 13 gives the measure of off gas flow rates from three different runs. It is obvious that flow rate is related to the feed gas pressure. The flow rate at 30 psi feed gas pressure is higher than the flow rate at 20 psi feed gas pressure.

There are quick flow rate droppings at the beginning of the operation. This quick dropping of the flow rate is possibly due to the quick plugging of the very small pores on the fiber wall. Although run #2 and run #3 have different fiber length, but the initial flow rate droppings are similar probably because of the similarity in pore size distribution, i.e. the similar amount of the small pore size on the fiber wall. The flow rates dropping are much smaller after the initial stage. The total fibre length of the third run is almost two times longer than second run, but the flow rate of the third run is not doubled. If the fiber is too long, the fact of pressure drop along the fibre wall will cause additional pore plugging. Therefore, it may be a good idea to increase the total membrane surface area by increases the number of fiber instead of length of the fiber.

[image]

A Few Conclusive Points For Polysulfone Hollow Fiber Sparger

1. Polysulfone hollow fiber used as a sparger works fine in inorganic based absorbing solution in a reasonable period of time.

2. It can be revitalized by simply was hing the fiber with water.

3. The average absorbing efficiency the hollow fiber sparger is 99%.

### Selection of Reactant Chemical

Typically, the processes employ an aqueous solution of a salt containing sodium or potassium as the cation with an anion so selected that the resulting solution is buffered at a pH about 9-1 1. Such a solution, being alkaline in nature, will absorb CO₂ and other acid gases. Salts, which have been proposed for processes of this type, include sodium and potassium carbonates, phosphate, borate, arsenite and phenolate, as well as salts of weak organic acid. Sodium and potassium carbonate solutions have been used extensively of the absorption of CO₂ from gas stream because of their low cost and ready availability.

The success of the absorption and desorption of carbon dioxide in a solution of alkali carbonate depends upon the reversibility of the reaction. The reaction equilibrium tends to go towards the right at low temperature and towards left at higher temperature. There are some other factors could influence the reaction reversibility, such as high pressure or high partial pressure of CO₂ could also shift the reaction equilibrium to right, as well as the strength of potassium carbonate strength.

Very general comparisons are given in Table 15 for an over all evaluation. The MEA is selected as a representative for amine-based solution to compare with other absorbing solutions. The comment of fast and slow, high and low are relative to each other. Over all the potassium carbonate with additives would be the better choice. But there are other amine-based solutions such as MEA with promoter would delivery even better results. The attraction of using aqueous ammonia as absorbing solution is the by-product, ammonium bicarbonate, which can be used as fertilizer in the developing countries. For the application of producing CO₂ from flue gas, the regeneration of CO₂ has to incorporate a waterwashing tower to reabsorb the NH₃ in the regeneration cycle.

TABLE 15
General comparison of the processes
using different absorbing solutions

| | | | Potassium | |
|---|---|---|---|---|
| Most | | | Carbonate | |
| Concerned | | Potassium | with | Aqueous |
| Aspects | MEA | Carbonate | promoter | Ammonia |
| Absorbing | Fast | Slow | Fast | Fast |
| Reaction rate | | | | |
| Solvent make | Yes | No | No | No |
| Up | | | | |
| Regeneration | Low | High | Low | High |
| Energy | | | | |
| Corrosion | High | Low | Low | High |
| Capital cost | Low | High | Low | No data |

The major drawback in a conventional potassium carbonate solution absorbing process is the slow reaction rate. The consequences of the slow reaction rate are the lower carbonate to bicarbonate conversion rate and higher cost of steam for CO₂ regeneration. Two advantages of using hollow fiber membrane modules, 1) much higher gas liquid contact surface area, 2) a more controllable gas and liquid phases pressures, and flow rates, would compensate slow absorbing reaction rate. If a specific condition with higher carbonate to bicarbonate conversion rate can be found with hollow fiber as absorber, the regeneration energy could also be reduced significantly. The advantages of no solvent degradation and oxidation of potassium carbonate will additionally reduce the operating cost.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defmed in the claims.

1. A method of chemically treating an acid gas, comprising the steps of:
immersing a micro-porous membrane having a plurality of micro-pores in a liquid containing a reactant chemical; and
passing a gas stream containing an acid gas under pressure through the micro-porous membrane whereby the acid gas passes through the micro-pores to form micro-bubbles which float up through the liquid and react with the reactant chemical.

2. The method as defined in claim 1, the micro-porous membrane being configured as a hollow fibre.

3. The method as defined in claim 2, the micro-porous hollow fibre membrane being in the form of at least one loop with opposed ends, the acid gas being fed into the at least one loop from one of the opposed ends, with an other of the opposed ends being blocked.

4. The method as defined in claim 2, the micro-porous hollow fibre membrane being in the form of at least one loop with opposed ends, the acid gas being fed into the at least one loop from each of the opposed ends.

5. The method as defined in claim 2, the micro-porous hollow fibre membrane being in the form of a module containing a plurality of loops.

6. The method as defined in claim 1, the acid gas being carbon dioxide (CO₂).

7. The method as defined in claim 1, the acid gas being hydrogen sulphide (H₂S).

8. The method as defined in claim 1, the reactant chemical being an aqueous-amine based solvent.

9. The method as defined in claim 1, the reactant chemical being an inorganic salt-based absorbing solvent.

10. The method as defined in claim 1, the reactant chemical being potassium carbonate (K₂CO₃).

11. The method as defined in claim 1, involving a further step of steam regeneration of the liquid containing the reactant chemical.

12. A method of chemically treating an acid gas, comprising the steps of:
immersing a micro-porous hollow fibre membrane module having a plurality of micro-porous hollow fibre membrane loops in a liquid containing an inorganic salt-based absorbing solvent as a reactant chemical, each of the micro-porous hollow fibre membranes loops having a plurality of micro-pores;
filing the micro-porous hollow fibre membrane with a gas stream containing an acid gas under pressure whereby the acid gas passes through the micro-pores to form micro-bubbles which float up through the liquid and react with the reactant chemical; and
regenerating the reactant chemical.

13. The method as defined in claim 12, the acid gas being carbon dioxide (CO₂).

14. The method as defined in claim 12, the acid gas being hydrogen sulphide (H₂S).

15. The method as defined in claim 12, the reactant chemical being an aqueous-amine based solvent.

16. The method as defined in claim 12, the reactant chemical being potassium carbonate (K₂CO₃).

17. A method of chemically treating CO₂, comprising the steps of:
immersing a micro-porous hollow fibre membrane module having a plurality of micro-porous hollow fibre membrane loops in a liquid containing an inorganic salt-based absorbing solvent capable of reacting in a reversible reaction with CO₂ as a reactant chemical, each of the micro-porous hollow fibre membranes loops having a plurality of micro-pores;
filling the micro-porous hollow fibre membrane with CO₂ under pressure whereby the CO₂ passes through the micro-pores to form micro-bubbles which float up through the liquid and react with the reactant chemical; and
regenerating the reactant chemical through a steam regeneration process.

18. The method as defined in claim 17, the reactant chemical being potassium carbonate (K₂CO₃).

19. The method as defined in claim 17, the micro-porous hollow fibre membrane being polysulfone fibre.

20. A gas absorption column, comprising:
a housing adapted to hold a liquid containing a reactant chemical, the housing having a gas inlet and a gas outlet; and
a micro-porous membrane having a plurality of micro-pores interposed between the gas inlet and the gas outlet, such that a gas stream containing an acid gas entering the housing under pressure through the gas inlet must pass through the micro-porous membrane in order to exit the housing via the gas outlet, the gas stream passing through the micro-pores as micro-bubbles which float up through the liquid in order to reach the gas outlet while a reaction occurs between the acid gas and the reactant chemical in the liquid;
the micro-porous membrane being configured as a sparger module which includes:
a mounting plate having a first face, a second face, a plurality of openings extending through the mounting plate between the first face and the second face;
a plurality of micro-porous hollow fibre membrane loops having opposed ends, each of the opposed ends being in fluid communication with one of the openings on the second face, such that acid gas entering the openings from the first face of the mounting plate passes into the opposed ends of the micro-porous hollow fibre membrane loops as it reaches the second face of the mounting plate and can only exit the micro-porous hollow fibre membrane loops by passing through the micro-pores.

21. The gas absorption column as defined in claim 20, wherein the housing has a liquid inlet and a liquid outlet, means being provided to circulate the liquid containing the reactant chemical into the housing through the liquid inlet and out of the housing through the liquid outlet.

22. The gas absorption column as defined in claim 21, wherein the liquid outlet and the liquid inlet are connected to a recovery and regeneration unit, such that liquid is continuously drawn from the liquid outlet into the regeneration unit for regeneration and regenerated liquid is returned to the liquid inlet.

23. The gas absorption column as defined in claim 20, wherein the micro-porous hollow fibre membrane is polysulfone fibre.
